(19) United States
(12) Patent Application Publication
(10) Pub. No.: US 2004/0248552 A1
(43) Pub. Date: Dec. 9, 2004

(54) Remote automated voting and electoral system ("RAVES")

(76) Inventors: Michael Le Mazurick, Avon, CT (US); Daniel Alfred Melanson, Canton, CT (US)

Correspondence Address: Melanson, Daniel Alfred, 6 Colony Road, Canton, CT, 06019, US

(21) Appl. No.: 10/441,226

(22) Filed: May 20, 2003

(51) Int. Cl. H04M 1/66; H04M 1/68

(52) U.S. Cl. 455/411; 379/88.01

(57) ABSTRACT

The invention comprises one or more Interactive Voice Response (“IVR”) computers connected both to the public telephone system, through telephone lines, and, through a private network, to a central processing computer with a voter information database and a separate database of voting results. The IVR computers can identify an individual voter through security information given when the citizen registered to vote; the computers then employ that information to obtain and secure a single, accurate ballot from the voter. The voting-results database is in no way connected to the voter-identification database or identification of the voter. At the close of voting, the invention connects securely to the central office administering the election and sends the tabulated results of all votes.

### CROSS-REFERENCE TO RELATED APPLICATIONS

Not applicable.

### FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention pertains to the field of telephone voting systems, as well as being a program for use in elections. More particularly, the Remote Automated Voting and Electoral System (“RAVES”) is designed to permit access for all voters, including the disabled and elderly, with a new secure method for all voters to gain access to a telephonic ballot through the public telephone network; and RAVES enhances the integrity of the voting process by implementing advanced security and vote-confirmation features, while potentially increasing voter participation as it brings the voting process into the citizen's home.

Modern elections are administered on a large scale. Data is collected from individual voters in numerous localities (generally, towns, cities, or counties) throughout the country, then transferred to the local registrars or election administrators. The collection of voting results is afterward transferred to a statewide level, and finally from states to the federal level.

As a result of new voting technology (e.g., Internet voting or electronic voting devices), there is considerable concern regarding the ability of computer experts to “hack”, distort, or even control the election process. For example, a computer programmer might create a program having a user interface that penetrates the Internet voting system and allows the programmer actually to change the resultant counts of the collected electronicly cast or Internet-cast ballots. All Internet and electronic voting systems present this problem because of common networking practices which allow connectivity through numerous data interfaces during the processes of collecting or transferring ballots.

Voting is intended to be a private matter in which a voter can cast a ballot without fear of judgment or reaction. Governmental regulations forbid voting systems, regardless of type, to establish audit trails that would allow a particular ballot to be traced back to a specific voter. This standard of anonymity increases the difficulty of maintaining the security of the voting process needed to ensure the integrity of the system.

All enfranchised citizens should be enabled to vote and to have their votes counted accurately and fairly. These citizens should include persons who have disabilities or handicaps which might restrict their ability to travel to a common site to cast their ballots. It is difficult to provide a solution that allows disabled or handicapped voters to vote without hindrance while respecting their right to privacy.

Interactive Voice Response units provide this technology through tone-based applications, voice-based applications, and combinations of both.

### BRIEF SUMMARY OF THE INVENTION

The Remote Automated Voting and Electoral System (“RAVES”) is a telephone voting system that uses existing Interactive Voice Response (“IVR”) technology and the public telephone network to allow callers access to a centralized voting system, whereby an individual's ballot can be counted quickly and accurately while ensuring the security and anonymity of the voter and protecting against fraud and error in the voting process.

The present invention overcomes problems mentioned above by providing complete access by all voters through their own residential telephone lines. The invention also provides the means of authentication by recognizing the source of an incoming voter's telephone line, placing a return call to the matching telephone number with the security information collected during the voter registration process, and verifying this information during the call; this procedure provides an effective, tamper-proof process for gathering an anonymous and accurate vote. This data then is securely transmitted (after validation by the local device) to the appropriate state official through a secure private network or by courier which can then be loaded into the central system and counted within minutes.

### BRIEF DESCRIPTION OF THE SEVERAL VIEWS OF THE DRAWING

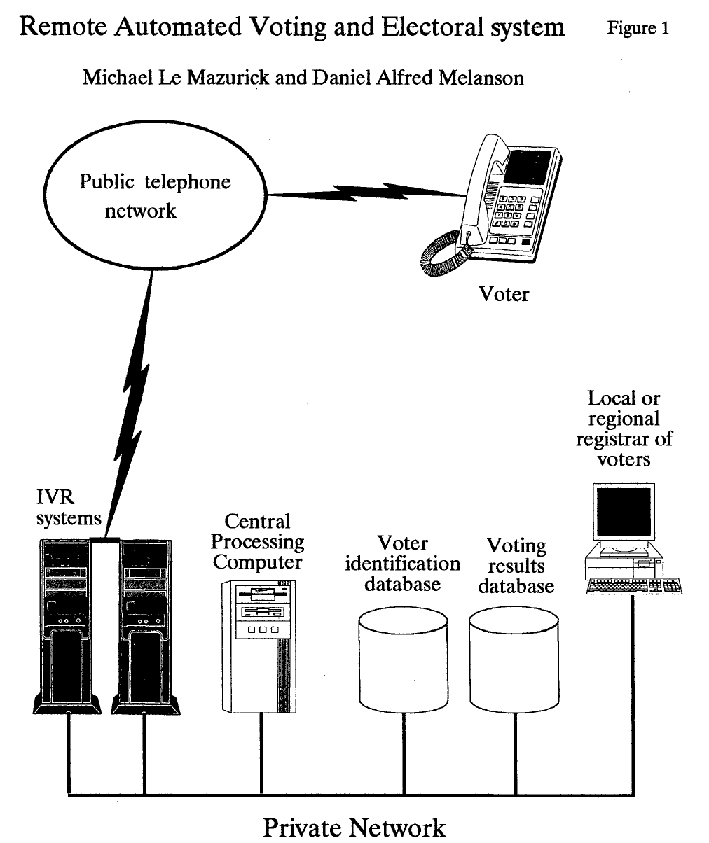

The sole drawing submitted herewith is FIG. 1, which is a depiction in schematic form of the configuration of the Remote Automated Voting and Electoral System. An individual Voter (represented by a sketch of a telephone set) may place his vote through the Public telephone network. His vote is collected, together with others, through IVR systems; verified through a Voter identification database within the voting district; and brought through a Central Processing Computer into a Voting results database. The System may be administered by a Local or regional registrar of voters (or equivalent officials in particular jurisdictions).

### DETAILED DESCRIPTION OF THE INVENTION

The invention, the Remote Automated Voting and Electoral System (“RAVES”), comprises one or more Interactive Voice Response (“IVR”) computers connected both to the public telephone system, through telephone lines (which may be tollfree), and, through a private network, to a central processing computer with a voter information database and a separate database of voting results. The IVR computers can identify an individual voter through security information given when the citizen registered to vote, verifying the caller by checking information given against data stored in the voter-identification database; the computers then employ that information to obtain and secure a single, accurate ballot from the voter. The voting-results database is in no way connected to the voter-identification database or identification of the voter. At the close of voting, the invention connects securely to the central office administering the election and sends the tabulated results of all votes.

The working of RAVES may be seen in the following example of a single call to vote. Although the specific format of any particular call may vary from this example, each call would contain the same essential components.

A voter places a telephone call to RAVES, using a tollfree telephone number established specifically for the election. That call leads to an IVR computer which requests specific and unique information from the voter, then verifies (against information contained in the voter-identification database compiled in the process of registering voters) both the information given and the telephone number from which the voter called. Next, the IVR system instructs the voter to disconnect and to wait for a return call. RAVES places a return telephone call to the voter to ensure positive identification of the voter, requesting final secure information from the voter, and recording the voter's ballot. Upon completion of the voter's ballot, the IVR and RAVES secure the results to prevent and changes to or tampering with the results.

We claim:

1: A telephone voting system for use in elections, comprising: a centralized Interactive Voice Response (“IVR”) system connected via a Private Local Area Network (“PLAN”) or a Virtual Private Network (“VPN”) to a secure server which collects the totals of voting information gathered from the callers and is maintained and secured by the local and/or regional registrar of voters.

2: The telephone voting system set forth in claim 1, wherein the centralized IVR system receives the call, identifies the caller's incoming telephone line, and authenticates the caller by making a return call to the voter's registered telephone number and validating the caller by using the voter's preselected Personal Identification Number (“PIN”), which PIN was acquired during the normal voter-registration process.

3: The telephone voting system set forth in claim 1, wherein the centralized IVR system receives the call and identifies the caller's incoming telephone line and authenticates the caller by means of the voter's PIN, which PIN was acquired during the normal voter-registration process.

4: The telephone voting system set forth in claim 1, wherein the centralized IVR system receives the call and identifies the caller's incoming telephone line and authenticates the caller via voice-print technology and other voter personal identification methods which were acquired during the normal voter-registration process.

5: The telephone voting system set forth in claim 1, wherein the centralized IVR system collects the calling voter's ballot but does not connect the record of vote to any identification of said calling voter, instead merely saving an anonymous record of sequential votes.

6: The telephone voting system set forth in claim 1, wherein the centralized IVR system is programmed with logic for presenting the voter with that precinct's specific electoral information for all ballotted contests and referenda, whether federal, state, or local.

7: The telephone voting system set forth in claim 1, wherein the centralized IVR system is programmed with logic for identifying the caller's address by the use of ANI or DNIS through a PRI-T1 ISDN-type connection.

8: The telephone voting system set forth in claim 7, wherein said identification is made by currently employed caller identification.

9: The telephone voting system set forth in claim 1, wherein a majority of certain preselected correct admission criteria would allow access and a majority of incorrect admission criteria would prevent access, causing the caller to be redirected to the appropriate voter administrator.

10: The telephone voting system set forth in claim 1, wherein the program logic set forth in claim 7 allows the registrar of voters to verify relevant information regarding a voter through provision of additional personal information by means of secure electronic mail, facsimile transmission, or text-to-speech callback when the voter forgets or loses his or her authenticating PIN.

11: The telephone voting system set forth in claim 1, wherein said telephonic ballot information is present to a voter based on area code or telephone exchange of originating call or by toll-free telephone numbers given to the voter based upon his or her geographic location.

12: The telephone voting system set forth in claim 1, wherein said telephonic ballot can be cast by means of touch-tone entries on the telephone keypad, by voice recognition of a caller's speech, or by combinations of both.
